(19) United States
(12) Patent Application Publication
(10) Pub. No.: US 2025/0187880 A1
(43) Pub. Date: Jun. 12, 2025

(54) SELF-ENGAGING, SELF-RELEASING CRANE HOOK

(71) Applicant: Michael ESTESS, Nevada City, CA (US)

(72) Inventor: Michael ESTESS, Nevada City, CA (US)

(21) Appl. No.: 18/536,928

(22) Filed: Dec. 12, 2023

(51) Int. Cl. B66C 1/38

(52) U.S. Cl. CPC B66C 1/38

(57) ABSTRACT

A self-engaging, self-releasing crane hook is disclosed. Example embodiments are directed to a self-engaging, self-releasing crane hook comprising: a hook frame element configured in an inverted U-shape; a load support bar pivotally coupled to the hook frame element; a load support bar catch pivotally coupled to the hook frame element, an end of the load support bar configured to releasably engage a lower edge of the load support bar catch; and a catch release bar pivotally coupled to the hook frame element, an end of the catch release bar configured to releasably engage an upper edge of the load support bar catch.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the disclosure provided below and to the drawings that form a part of this document: Copyright 2022-2023 Michael ESTESS, All Rights Reserved.

### TECHNICAL FIELD

This patent application relates to crane hooks according to an example embodiment, and more specifically to a self-engaging, self-releasing crane hook.

### BACKGROUND

Crane-supported hooks are widely used for moving heavy loads to or from docks, ship decks, solid land, the sea bottom, and so on. It is of great advantage if, upon “touch down” of the load, the hook will automatically release itself from the load by pushing a cable or shackle out of engagement with the hook, in such a way that it will stay out of engagement for a period of time. This is particularly useful when the location of the “touch down” of the load is not easily reached by a person in order to disconnect the hook from the load. Similar problems arise when the load and the place of “touch down” are moving in an uncontrolled manner towards or away from each other, for example from one ship to another ship, from a helicopter, for lowering lifeboats, and the like. By providing immediate release of the load from the hook, there is no danger that the load will be lifted again, and no likelihood of smashing or pounding.

However, conventional crane hooks often use spring-loaded catches or pneumatic releases to disengage the hook from the load. These mechanisms can jam or may require an operator to activate a separate release device or a separate arming device. Moreover, conventional crane hooks don't provide a combination of a self-releasing feature with a self-engaging feature.

### BRIEF DESCRIPTION OF THE DRAWINGS

The various embodiments are illustrated by way of example, and not by way of limitation, in the figures of the accompanying drawings in which:

FIG. 1 illustrates a frontal view of the self-engaging, self-releasing crane hook of an example embodiment, which is configured to receive a load;

FIG. 2 illustrates a side view of the self-engaging, self-releasing crane hook of an example embodiment, which is configured to receive a load;

FIG. 3 illustrates the self-engaging, self-releasing crane hook of an example embodiment, wherein the load has engaged the load support bar;

FIG. 4 illustrates the self-engaging, self-releasing crane hook of an example embodiment, wherein the load support bar has dropped into a load support position, thereby self-engaging the load;

FIG. 5 illustrates the self-engaging, self-releasing crane hook of an example embodiment, wherein the load support bar is in position to enable the crane hook to lift and support the load;

FIG. 6 illustrates the self-engaging, self-releasing crane hook of an example embodiment, wherein the load has engaged the catch release bar;

FIG. 7 illustrates the self-engaging, self-releasing crane hook of an example embodiment, wherein the movement of the catch release bar has caused the load support bar catch to disengage the load support bar, which causes the load support bar to drop into a load release position, thereby self-releasing the load;

FIG. 8 illustrates the self-engaging, self-releasing crane hook of an example embodiment, wherein the components of the crane hook are reset to self-engage and lift a new load; and

FIG. 9 illustrates a method of an example embodiment.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

This patent application relates to crane hooks according to an example embodiment, and more specifically to a self-engaging, self-releasing crane hook. The various example embodiments are described below and illustrated in the drawings included herewith.

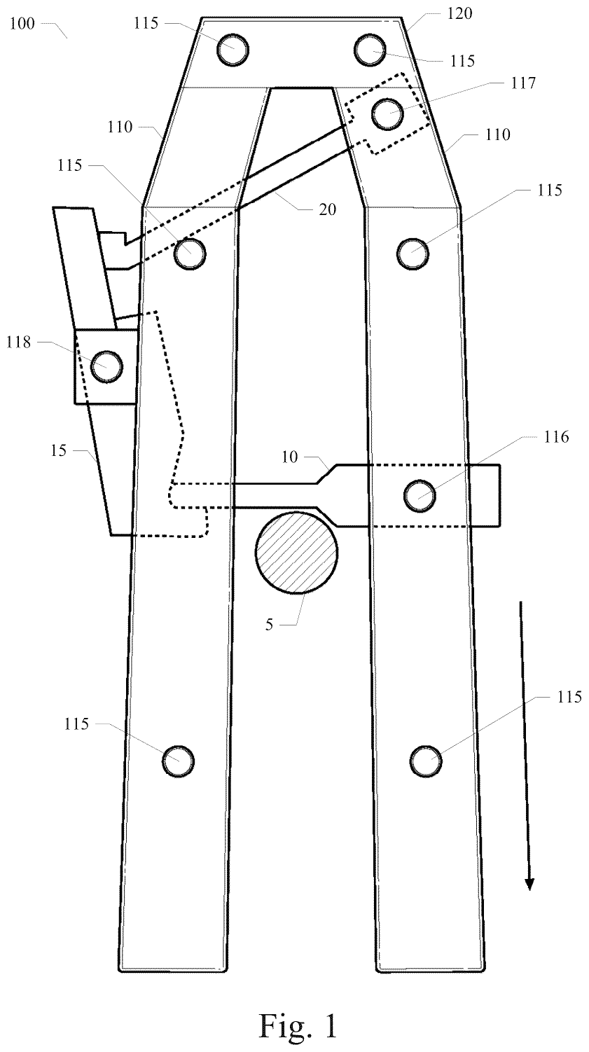

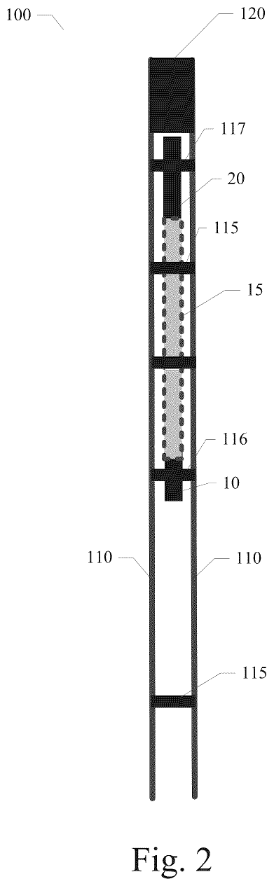

FIG. 1 illustrates a frontal view of the self-engaging, self-releasing crane hook 100 of an example embodiment, which is configured to receive a load 5. FIG. 2 illustrates a side view of the self-engaging, self-releasing crane hook 100 of an example embodiment, which is configured to receive the load 5. Referring to FIGS. 1 and 2, the crane hook 100 of an example embodiment can be fabricated in an inverted U-shape or V-shape configuration with two hook frame elements 110 attached at the top by a hook frame crossbar 120. Each of the two hook frame elements 110 can be fabricated as two parallel plates attached together with bolts or other attachment means 115 (e.g., see FIG. 2). Given the configuration of the two attached parallel plates of the hook frame elements 110, an end of a load support bar 10 can be attached between the two attached parallel plates of the hook frame element 110 with a bolt or other attachment means 116. By use of the bolt or other attachment means 116, the load support bar 10 is pivotally attached to enable the load support bar 10 to swing vertically between the two attached parallel plates of the hook frame elements 110. An opposite end of the load support bar 10 is configured to releasably engage a lower edge of a load support bar catch 15 when the load support bar 10 is in a load support position. When the load support bar 10 is disengaged from the load support bar catch 15, the load support bar 10 drops or pivots into a load release position between the two attached parallel plates of the hook frame element 110. This action of the load support bar 10 is described in more detail below.

Given the configuration of the two attached parallel plates of the hook frame elements 110, an end of a catch release bar 20 can be attached between the two attached parallel plates of the hook frame element 110 with a bolt or other attachment means 117. By use of the bolt or other attachment means 117, the catch release bar 20 is pivotally attached to enable the catch release bar 20 to swing vertically between the two attached parallel plates of the hook frame elements 110. An opposite end of the catch release bar 20 is configured to releasably engage an upper edge of the load support bar catch 15 when the load support bar catch 15 is in the load support position. The load support bar catch 15 can be pivotally attached to the hook frame element 110 with a bolt or other attachment means 118. When the catch release bar 20 is disengaged from the upper edge of the load support bar catch 15, the load support bar catch 15 drops, pivots, or otherwise moves into the load release position between the two attached parallel plates of the hook frame element 110. As a result of the load support bar catch 15 dropping or pivoting into the load release position, the lower edge of the load support bar catch 15 disengages from the load support bar 10. The load support bar catch 15 can be weighted or spring loaded to bias the load support bar catch 15 into the load release position when the catch release bar 20 is disengaged from the upper edge of the load support bar catch 15. When the load support bar 10 is disengaged from the lower edge of the load support bar catch 15, the load support bar 10 drops or pivots into the load release position between the two attached parallel plates of the hook frame element 110. This action of the catch release bar 20, the load support bar catch 15, and the load support bar 10 is described in more detail below.

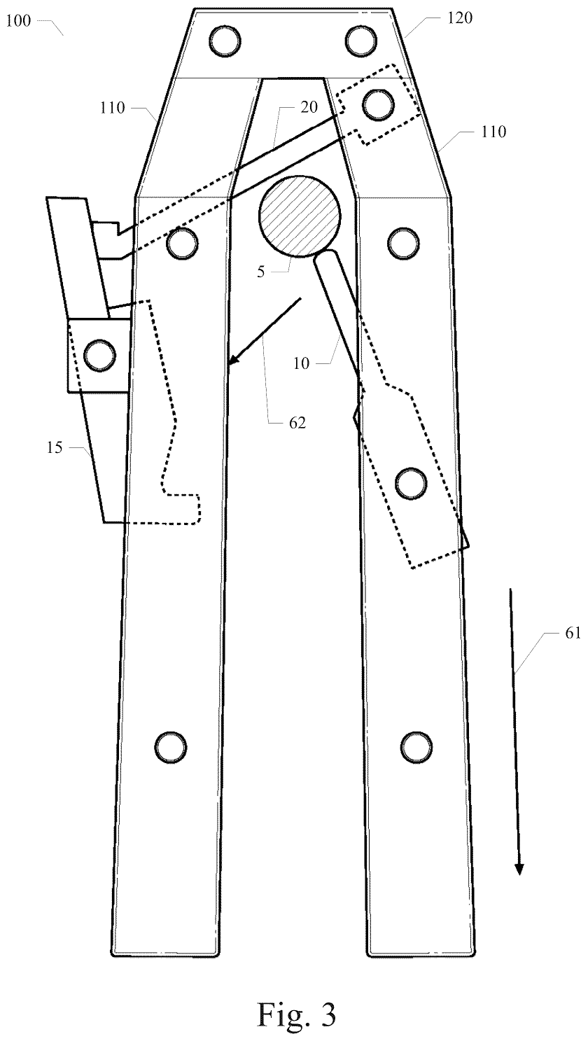

FIGS. 3 through 8 illustrate the action of the catch release bar 20, the load support bar catch 15, and the load support bar 10 of the crane hook 100 of an example embodiment when the crane hook 100 is used to lift the load 5. In the example embodiments described herein, the load 5 can represent any of a variety of different types of materials, equipment, tools, components, and the like, which need to be lifted or moved by a crane or other equipment.

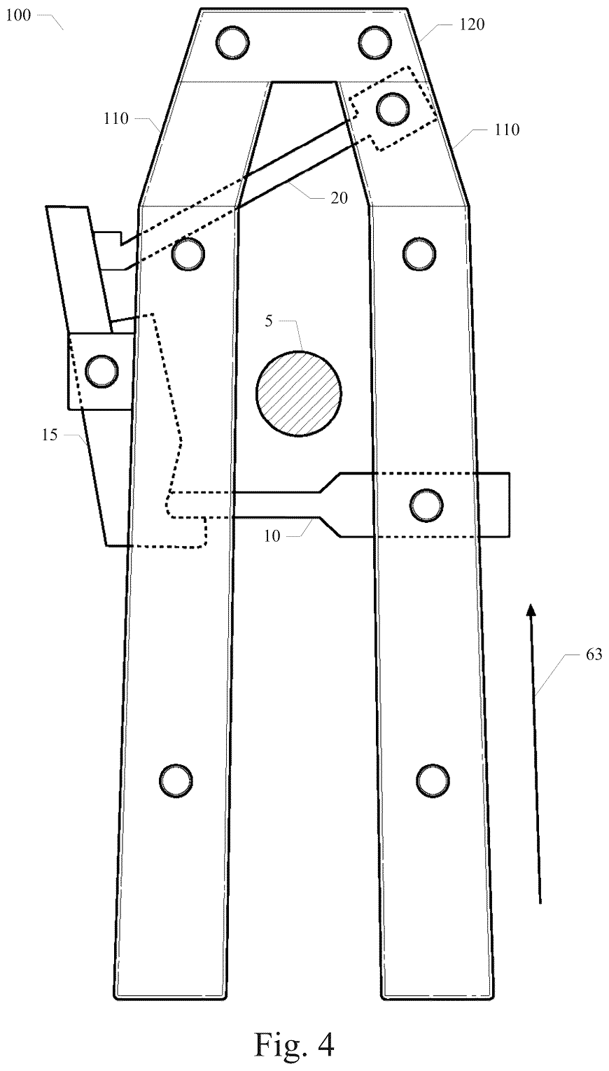

FIGS. 3 through 5 illustrate the self-engaging load support position operation of the crane hook 100 of an example embodiment. FIG. 3 illustrates the self-engaging, self-releasing crane hook 100 of an example embodiment, wherein the load 5 has engaged (i.e., made contact with) the load support bar 10. As shown in FIG. 3, the crane hook 100 can be lowered (see arrow 61) onto load 5, which causes load support bar 10 to deflect or rotate upwardly when in contact with the load 5. Once the load 5 has moved high enough inside of the hook frame elements 110, the load 5 clears the load support bar 10 causing the load support bar 10 to drop downwardly (see arrow 62). When the load support bar 10 drops downwardly, an end of the load support bar 10 engages the lower edge of the load support bar catch 15 as shown in FIG. 4. In this configuration, the crane hook 100 is in the load support position with the load 5 above the load support bar 10 and captured within the hook frame elements 110.

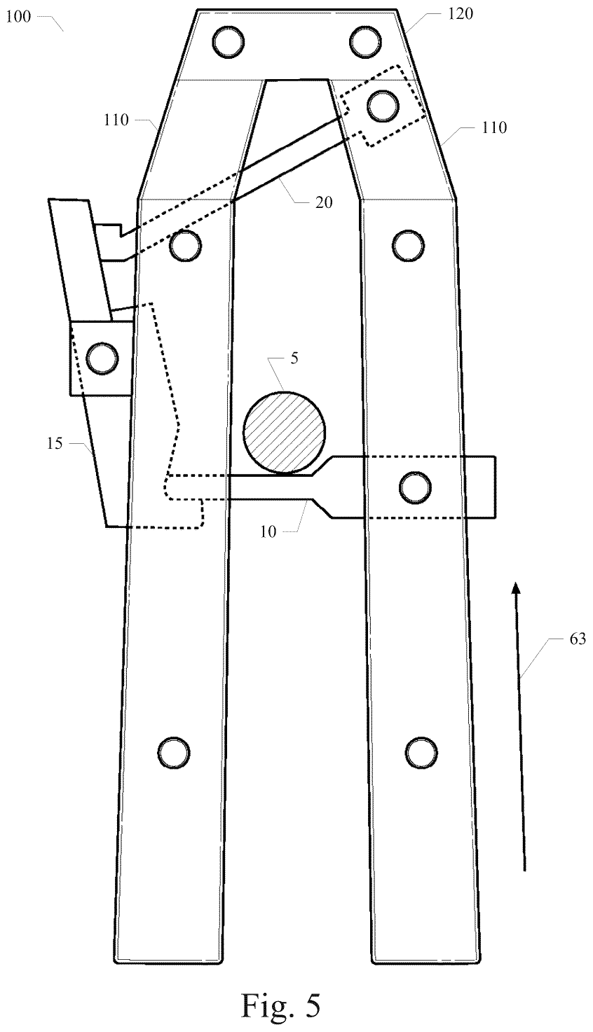

FIG. 4 illustrates the self-engaging, self-releasing crane hook 100 of an example embodiment, wherein the load support bar 10 has dropped into a load support position, thereby self-engaging the load 5. Referring now to FIG. 4, the load support bar 10 has engaged the lower edge of the load support bar catch 15. At this point, the crane hook 100 is in the load support position with the load 5 captured within the hook frame elements 110. As shown by arrow 63 in FIGS. 4 and 5, the crane hook 100 can be raised until the load 5 makes contact with the load support bar 10. The crane hook 100 can be further raised as the load 5 is supported by the load support bar 10. FIG. 5 illustrates the self-engaging, self-releasing crane hook 100 of an example embodiment, wherein the load support bar 10 is in position to enable the crane hook 100 to lift and support the load 5.

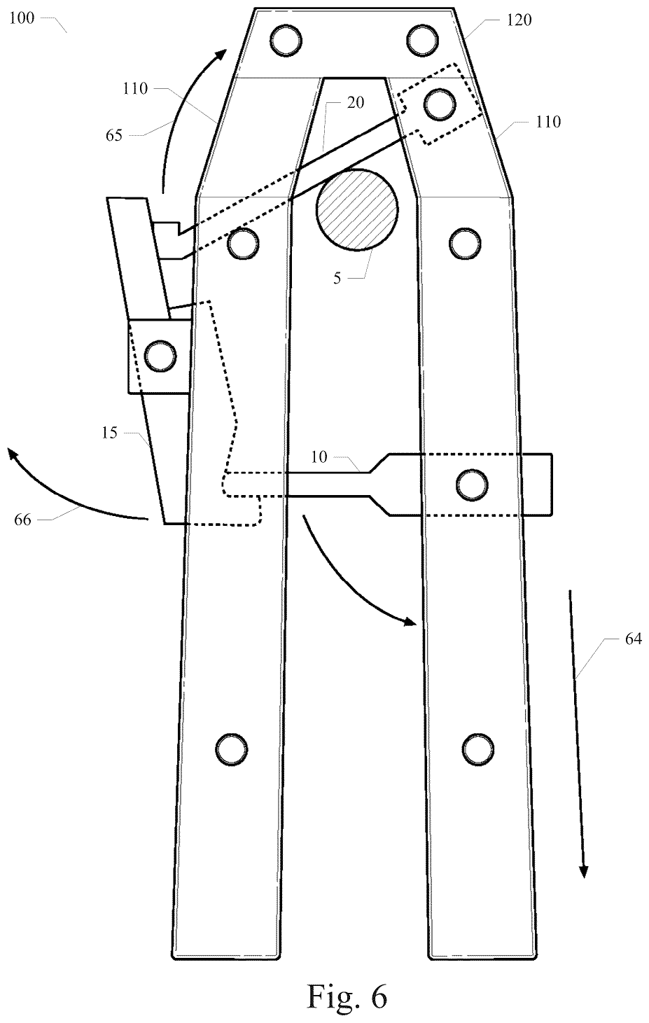

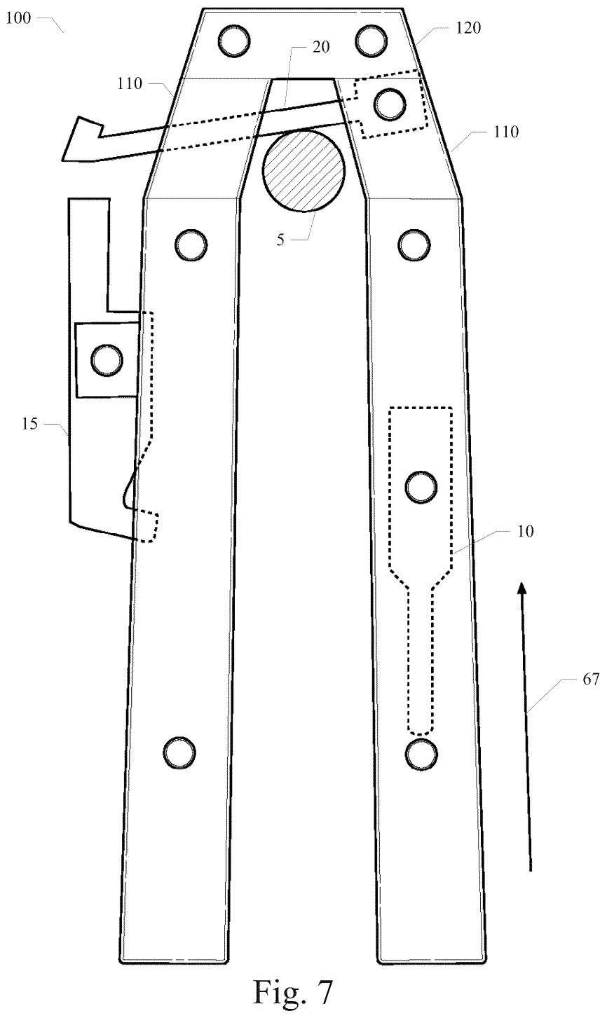

FIGS. 6 and 7 illustrate the self-releasing load release position operation of the crane hook 100 of an example embodiment. FIG. 6 illustrates the self-engaging, self-releasing crane hook 100 of an example embodiment, wherein the load 5 has engaged (i.e., made contact with) the catch release bar 20. As shown in FIG. 6, the crane hook 100 can be lowered (see arrow 64) to cause load 5 to make contact with the catch release bar 20, which causes the catch release bar 20 to deflect upwardly (see arrow 65). Once the load 5 has moved high enough inside of the hook frame elements 110, the load 5 deflects the catch release bar 20 upwardly far enough to disengage an end of the catch release bar 20 from the upper edge of the load support bar catch 15. Disengagement of an end of the catch release bar 20 causes the load support bar catch 15 to drop or pivot into a load release position (see arrow 66). When the load support bar catch 15 drops or pivots into the load release position, the lower edge of the load support bar catch 15 disengages from the load support bar 10. The load support bar catch 15 can be weighted or spring loaded to bias the load support bar catch 15 into the load release position when the catch release bar 20 is disengaged from the upper edge of the load support bar catch 15. When the load support bar 10 is disengaged from the lower edge of the load support bar catch 15, the load support bar 10 drops or pivots downwardly into a load release position between the two attached parallel plates of the hook frame element 110 as shown in FIG. 7.

FIG. 7 illustrates the self-engaging, self-releasing crane hook 100 of an example embodiment, wherein the movement of the catch release bar 20 has caused the load support bar catch 15 to disengage the load support bar 10, which causes the load support bar 10 to drop into the load release position. In the load release position, the crane hook can be raised or lifted (see arrow 67) to cause the load 5 to exit the interior region of the hook frame elements 110. At this point, the crane hook 100 is free of the load 5, thereby self-releasing the load 5 by operation of the components of the crane hook 100 of an example embodiment as described herein.

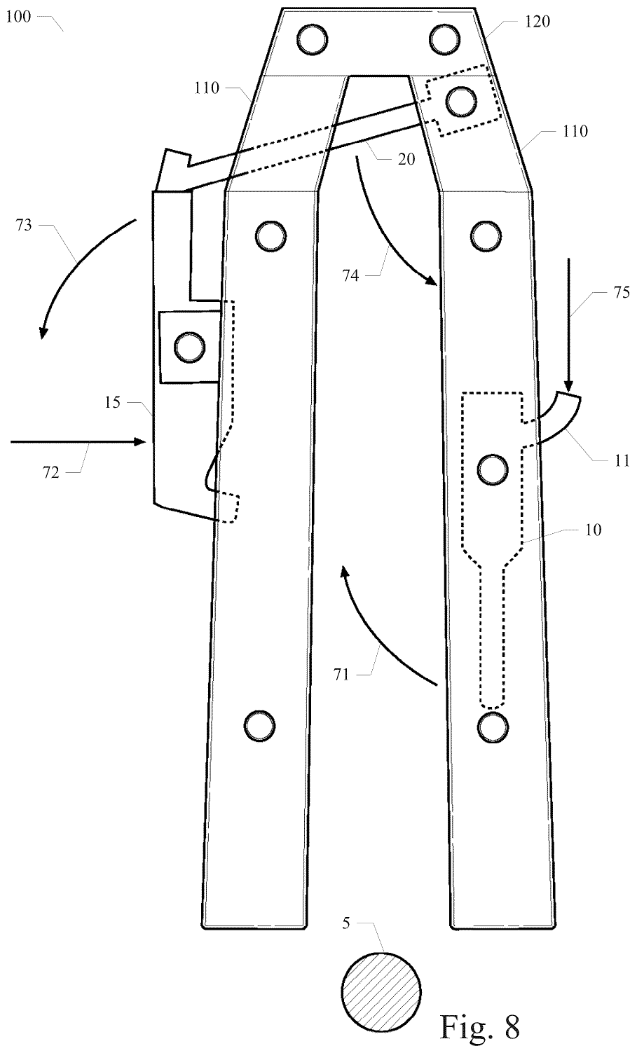

FIG. 8 illustrates the self-engaging, self-releasing crane hook 100 of an example embodiment, wherein the components of the crane hook 100 are reset to self-engage and lift a new load 5. Referring to FIG. 8, the crane hook 100 of an example embodiment is shown after releasing a load 5. Note that as shown in FIG. 8 and described above, the load support bar 10 and the load support bar catch 15 have dropped into the load release position. To reset the self-engaging, self-releasing crane hook 100 of an example embodiment for supporting a new load 5, the load support bar 10 can be manually lifted vertically (see arrow 71) into a slightly-above horizontal position using push tab 11. Next, the lower end of load support bar catch 15 can be pushed horizontally (see arrows 72 and 73) to engage an end of the load support bar 10. Finally, an end of the catch release bar 20 can be lowered to engage the upper end of the load support bar catch 15. As a result, the crane hook 100 of an example embodiment will be reset and configured in the manner shown in FIG. 1. In this reset configuration, the crane hook 100 of an example embodiment is ready to engage and lift a new load 5.

The crane hook 100 of an example embodiment, along with the components thereof, can be fabricated from a variety of materials including steel, aluminium, other metals, composite metals, composite materials, plastics, Polyvinyl Chloride (PVC or Vinyl), Acrylonitrile butadiene styrene (ABS), or other materials suitable to carry a load for particular applications.

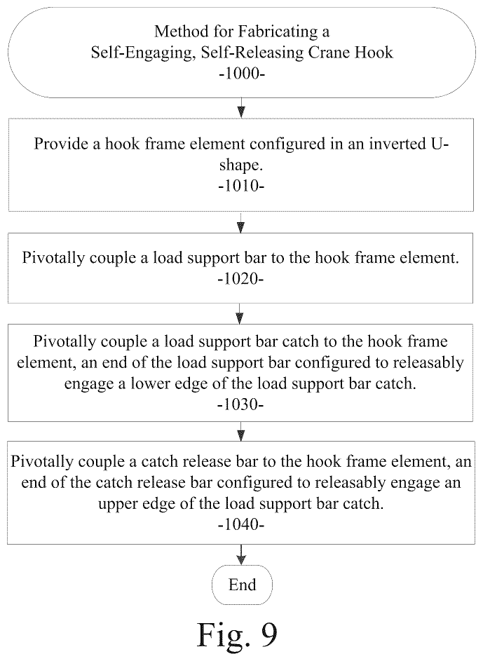

FIG. 9 illustrates a method of an example embodiment. The example embodiment can be configured to include a method 1000 for fabricating a self-engaging, self-releasing crane hook, the method comprising: providing a hook frame element configured in an inverted U-shape (operation 1010); pivotally coupling a load support bar to the hook frame element (operation 1020); pivotally coupling a load support bar catch to the hook frame element, an end of the load support bar configured to releasably engage a lower edge of the load support bar catch (operation 1030); and pivotally coupling a catch release bar to the hook frame element, an end of the catch release bar configured to releasably engage an upper edge of the load support bar catch (operation 1040).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A self-engaging, self-releasing crane hook comprising:
a hook frame element configured in an inverted U-shape;
a load support bar pivotally coupled to the hook frame element;
a load support bar catch pivotally coupled to the hook frame element, an end of the load support bar configured to releasably engage a lower edge of the load support bar catch; and
a catch release bar pivotally coupled to the hook frame element, an end of the catch release bar configured to releasably engage an upper edge of the load support bar catch.

2. The self-engaging, self-releasing crane hook of claim 1 wherein the hook frame element is configured as two parallel plates attached together with an attachment means.

3. The self-engaging, self-releasing crane hook of claim 1 wherein the hook frame element is configured as two parallel plates attached together with an attachment means and attached at a top end by a hook frame crossbar.

4. The self-engaging, self-releasing crane hook of claim 1 wherein the load support bar is configured to rotate upwardly when engaged by a load.

5. The self-engaging, self-releasing crane hook of claim 1 wherein the load support bar is configured to drop downwardly and engage the lower edge of the load support bar catch in a load support position when a load clears the load support bar.

6. The self-engaging, self-releasing crane hook of claim 1 wherein the load support bar is configured to disengage from the lower edge of the load support bar catch thereby causing the load support bar to drop or pivot into a load release position.

7. The self-engaging, self-releasing crane hook of claim 1 wherein the catch release bar is configured to disengage from the upper edge of the load support bar catch thereby causing the load support bar catch to move into a load release position.

8. The self-engaging, self-releasing crane hook of claim 1 wherein the load support bar includes a push tab to reset the load support bar.

9. The self-engaging, self-releasing crane hook of claim 1 wherein the load support bar catch is weighted or spring loaded to bias the load support bar catch into a load release position when the catch release bar is disengaged from the upper edge of the load support bar catch.

10. The self-engaging, self-releasing crane hook of claim 1 wherein the self-engaging, self-releasing crane hook is fabricated from a type of material selected from a group consisting of: steel, aluminium, other metals, composite metals, composite materials, plastics, Polyvinyl Chloride (PVC or Vinyl), and Acrylonitrile butadiene styrene (ABS).

11. A method for fabricating a self-engaging, self-releasing crane hook, the method comprising:
providing a hook frame element configured in an inverted U-shape;
pivotally coupling a load support bar to the hook frame element;
pivotally coupling a load support bar catch to the hook frame element, an end of the load support bar configured to releasably engage a lower edge of the load support bar catch; and
pivotally coupling a catch release bar to the hook frame element, an end of the catch release bar configured to releasably engage an upper edge of the load support bar catch.

12. The method of claim 11 wherein the hook frame element is configured as two parallel plates attached together with an attachment means.

13. The method of claim 11 wherein the hook frame element is configured as two parallel plates attached together with an attachment means and attached at a top end by a hook frame crossbar.

14. The method of claim 11 wherein the load support bar is configured to rotate upwardly when engaged by a load.

15. The method of claim 11 wherein the load support bar is configured to drop downwardly and engage the lower edge of the load support bar catch in a load support position when a load clears the load support bar.

16. The method of claim 11 wherein the load support bar is configured to disengage from the lower edge of the load support bar catch thereby causing the load support bar to drop or pivot into a load release position.

17. The method of claim 11 wherein the catch release bar is configured to disengage from the upper edge of the load support bar catch thereby causing the load support bar catch to move into a load release position.

18. The method of claim 11 wherein the load support bar includes a push tab to reset the load support bar.

19. The method of claim 11 wherein the load support bar catch is weighted or spring loaded to bias the load support bar catch into a load release position when the catch release bar is disengaged from the upper edge of the load support bar catch.

20. The method of claim 11 wherein the self-engaging, self-releasing crane hook is fabricated from a type of material selected from a group consisting of: steel, aluminium, other metals, composite metals, composite materials, plastics, Polyvinyl Chloride (PVC or Vinyl), and Acrylonitrile butadiene styrene (ABS).
